(19) United States
(12) Patent Application Publication
(10) Pub. No.: US 2010/0226441 A1
(43) Pub. Date: Sep. 9, 2010

(54) Frame Capture, Encoding, and Transmission Management

(75) Inventors: Jackson Tung, Saratoga, CA (US); Thomas Young, Foster City, CA (US); Kai Chee Li, Fremont, CA (US); Jeff B. Widergren, Mount View, CA (US); Hao Guo, Cupertino, CA (US); Francis A. Palita, Goodyear, AZ (US); Hua Zhou, San Jose, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/399,302

(22) Filed: Mar. 6, 2009

(51) Int. Cl. H04N 7/26

(52) U.S. Cl. 375/240.24; 375/E07.126

(57) ABSTRACT

Example embodiments of the present disclosure provide techniques for improving the rendering and management of client desktops and the subsequent transmission to the remote client. The techniques may minimize the movement of frame data within the server, the amount of data to be compressed, the amount of data transmitted over the network, and the amount of data to be decompressed. Various embodiments are disclosed for merging rendering functions and encoding functions onto the same chip so that frame data does not need to be transferred, calculation of a tile-based checksum for determining which tiles have changed from frame to frame, the dropping of tiles waiting to be transmitted if network bandwidth or decode speed is limiting the transmission and an equivalent tile in a subsequent frame is available to replace it, and the transfer of the frame buffer into the chip from an external GPU using one of three modes.

### CROSS-REFERENCE

This application is related by subject matter to the subject matter disclosed in the following commonly assigned applications, the entirety of which are hereby incorporated by reference herein: U.S. patent application Ser. No. ______ (Attorney Docket No. MVIR-534/326264.01) titled “Concurrent Encoding/Decoding Of Tiled Data,” U.S. patent application Ser. No. ______ (Attorney Docket No. MVIR-0537/326424.01) titled “Frame Buffer Management,” and U.S. Pat. No. 7,460,725 entitled “System And Method For Effectively Encoding And Decoding Electronic Information.”

### BACKGROUND

Remote computing systems can enable users to access resources hosted by the remote computing systems. Servers on the remote computing systems can execute programs and transmit signals indicative of a user interface to clients that can connect by sending signals over a network conforming to a communication protocol such as the TCP/IP protocol. Each connecting client may be provided a session, i.e., an execution environment that includes a set of resources. Each client can transmit signals indicative of user input to the server and the server can apply the user input to the appropriate session. The clients may use protocols such as the Remote Desktop Protocol (RDP) to connect to a server resource.

In a server-based computing environment, the rendering and management of the client desktops and the subsequent transmission to the remote client requires a great deal of resources. Such resources include computational cycles, memory for frame buffers, and network bandwidth. Furthermore, current systems may not effectively address network bandwidth issues. For example, in some systems every captured frame may be compressed. If the network is congested, then frames may be dropped and queued frames may only be sent when the network resources are eventually freed. As the server scalability continues to increase, better and more efficient ways of managing this process is needed. Thus, other techniques are needed in the art to solve the above described problems.

### SUMMARY

In various embodiments, methods and systems are disclosed for minimizing: 1) the movement of frame data within the server; 2) the amount of data to be compressed; 3) the amount of data transmitted over the network; and 4) the amount of data to be decompressed.

Various aspects are disclosed herein for a mechanism for (1) merging the rendering functions and the encoding functions onto the same chip so that frame data does not need to be transferred, (2) calculation of a tile-based checksum for determining which tiles have changed from frame to frame, (3) the dropping of tiles waiting to be transmitted if network bandwidth or decode speed is limiting the transmission and an equivalent tile in a subsequent frame is available to replace it, and (4) the transfer of the frame buffer into the chip from an external GPU using one of three modes: a) virtual frame mode; b) temporal frame mode; and b) changed-tile mode.

In addition to the foregoing, other aspects are described in the claims, drawings, and text forming a part of the present disclosure. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 1a illustrates a virtual machine environment, with a plurality of virtual machines, comprising a plurality of virtual processors and corresponding guest operating systems; the virtual machines are maintained by a virtualizing layer which may comprise a scheduler and other components, where the vitualizing layer virtualizes hardware for the plurality of virtual machines;

FIG. 2 thru 4 depict an operational environment for practicing aspects of the present disclosure.

FIG. 5 illustrates a block diagram depicting one embodiment of an encoding system.

FIG. 6 illustrates a block diagram depicting one embodiment of an decoding system.

FIG. 7 illustrates one embodiment of a frame differencing procedure.

FIG. 8 illustrates one embodiment of a frame reconstruction procedure.

FIG. 9 illustrates one embodiment of an entropy encoder.

FIG. 10 illustrates one embodiment of an entropy decoder.

FIG. 11 illustrates one embodiment of a multiple encoder-decoder architecture.

FIG. 12 illustrates one embodiment of a multiple image encoding/decoding procedure.

FIG. 13 illustrates one embodiment of tile data.

FIG. 14 illustrates a flowchart of operations for performing an encoding procedure.

FIG. 15 illustrates a flowchart of operations for performing a decoding procedure.

FIG. 16 illustrates flowchart of operations for performing an encoding procedure.

FIG. 17 illustrates one embodiment of data tile slice encoding procedure.

FIG. 18 illustrates one embodiment of data tile slice decoding procedure.

FIG. 19 illustrates an overview of processes disclosed herein.

FIG. 20 illustrates an exemplary diagram of a GPU and encoding hardware.

FIG. 21 illustrates an exemplary diagram of a virtual screen comprised of individual screens.

FIG. 22 illustrates an exemplary diagram of a temporal frame mode.

FIG. 23 illustrates an exemplary diagram of a temporal frame mode.

FIG. 24 illustrates an exemplary diagram of a changed tile mode.

FIG. 25 illustrates an exemplary diagram of a capture frame reprogramming procedure.

FIG. 26 illustrates an exemplary diagram illustrating the accumulation of changed tiles when dropping transmit frames.

FIG. 27 illustrates an example of an operational procedure for processing graphics data for transmission to a plurality of client computers.

FIG. 28 illustrates an example system for processing graphics data for transmission to a plurality of client computers.

FIG. 29 illustrates a computer readable medium bearing computer executable instructions discussed with respect to FIGS. 1-28.

### DETAILED DESCRIPTION

### Computing Environments in General Terms

Certain specific details are set forth in the following description and figures to provide a thorough understanding of various embodiments of the disclosure. Certain well-known details often associated with computing and software technology are not set forth in the following disclosure to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure.

It should be understood that the various techniques described herein may be implemented in connection with hardware or software or, where appropriate, with a combination of both. Thus, the methods and apparatus of the disclosure, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

A remote desktop system is a computer system that maintains applications that can be remotely executed by client computer systems. Input is entered at a client computer system and transferred over a network (e.g., using protocols based on the International Telecommunications Union (ITU) T.120 family of protocols such as Remote Desktop Protocol (RDP)) to an application on a terminal server. The application processes the input as if the input were entered at the terminal server. The application generates output in response to the received input and the output is transferred over the network to the client computer system. The client computer system presents the output data. Thus, input is received and output presented at the client computer system, while processing actually occurs at the terminal server. A session can include a shell and a user interface such as a desktop, the subsystems that track mouse movement within the desktop, the subsystems that translate a mouse click on an icon into commands that effectuate an instance of a program, etc. In another example embodiment the session can include an application. In this example while an application is rendered, a desktop environment may still be generated and hidden from the user. It should be understood that the foregoing discussion is exemplary and that the presently disclosed subject matter may be implemented in various client/server environments and not limited to a particular terminal services product.

In most, if not all remote desktop environments, input data (entered at a client computer system) typically includes mouse and keyboard data representing commands to an application and output data (generated by an application at the terminal server) typically includes video data for display on a video output device. Many remote desktop environments also include functionality that extend to transfer other types of data.

Communications channels can be used to extend the RDP protocol by allowing plug-ins to transfer data over an RDP connection. Many such extensions exist. Features such as printer redirection, clipboard redirection, port redirection, etc., use communications channel technology. Thus, in addition to input and output data, there may be many communications channels that need to transfer data. Accordingly, there may be occasional requests to transfer output data and one or more channel requests to transfer other data contending for available network bandwidth.

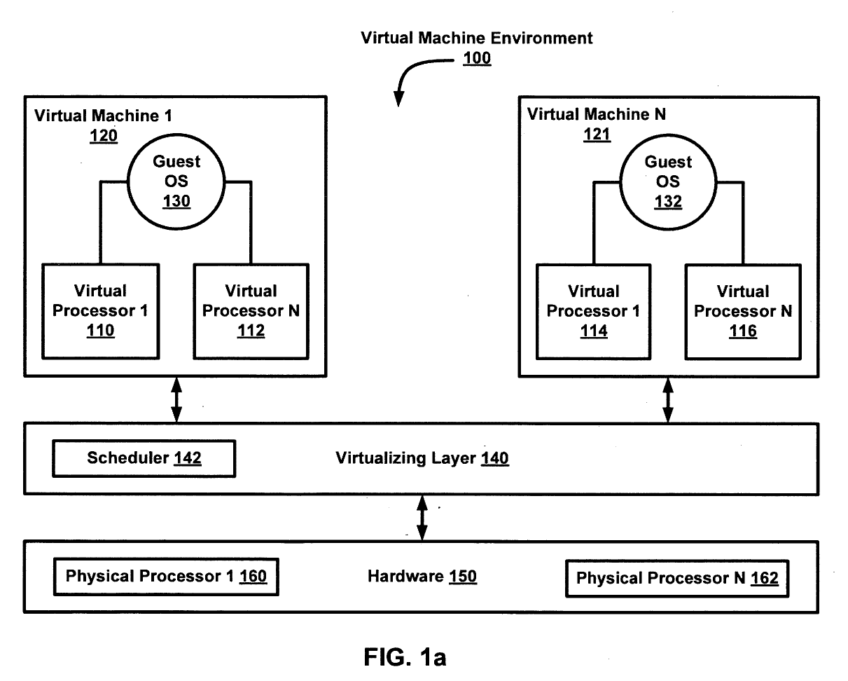

FIG. 2 shows an implementation 200 enabling terminal services. A TS client machine 202 and a TS 204 communicate using RDP. The TS client machine 202 runs a TS client process 206 that sends RDP input device data 208, such as for example keyboard data and mouse click data, to a TS session 210 that has been spawned on the TS and receives RDP display data 212, such as user interface graphics data. Generally, the TS client process 206 is a thin client process and most processing is provided on the TS 204.

FIG. 3 shows an implementation 300 enabling terminal services through a firewall 302. A remote TS client 304 connects to a terminal services gateway (TSG) 306 over a network 308. A Hypertext Transfer Protocol (HTTP) transport process 310 on the TS client and an HTTP process 312 on the TSG 306 facilitate communication through the firewall 302. The HTTP transport process 310 wraps data, such as Remote Procedure Call (RPC) data or RDP data, in HTTPS headers for the TSG 306. The TSG 306 may connect to the TS 314 over a socket connection 318 via a socket out process 316. Once the TS client 304 is authenticated and a connection is established, RDP data 320 may be passed back and forth between the TS client 304 and the TS 314.

FIG. 4 shows a generalized example of an implementation 400, wherein an existing remote procedure call/hypertext transport protocol (RPC/HTTP) proxy is leveraged, thereby providing a terminal services protocol, such as RDP, over an RPC/HTTP connection through a firewall 402. The architecture of the implementation illustrates that by wrapping the RDP protocol within RPC calls, an existing RPC-based proxy can be advantageously utilized. In particular, an RPC Transport Plug-In 404 on the TS client 406 wraps an RDP stream providing communication between the TS client 406 and the terminal server 408 within an RPC protocol. This facilitates utilization of an RPC-based proxy, thereby enabling firewall navigation. The RPC-based proxy 410, which may run in a user-mode on the TS, can forward received data to a socket listener 412, which may run in kernel-mode on the TS.

As discussed above, clients may use a remote protocol such as Remote Desktop Protocol (RDP) to connect to a resource using terminal services. When a remote desktop client connects to a terminal server via a terminal server gateway, the gateway may open a socket connection with the terminal server and redirect client traffic on the RDP port or a port dedicated to remote access services. The gateway may also perform certain gateway specific exchanges with the client using a terminal server gateway protocol transmitted over HTTPS.

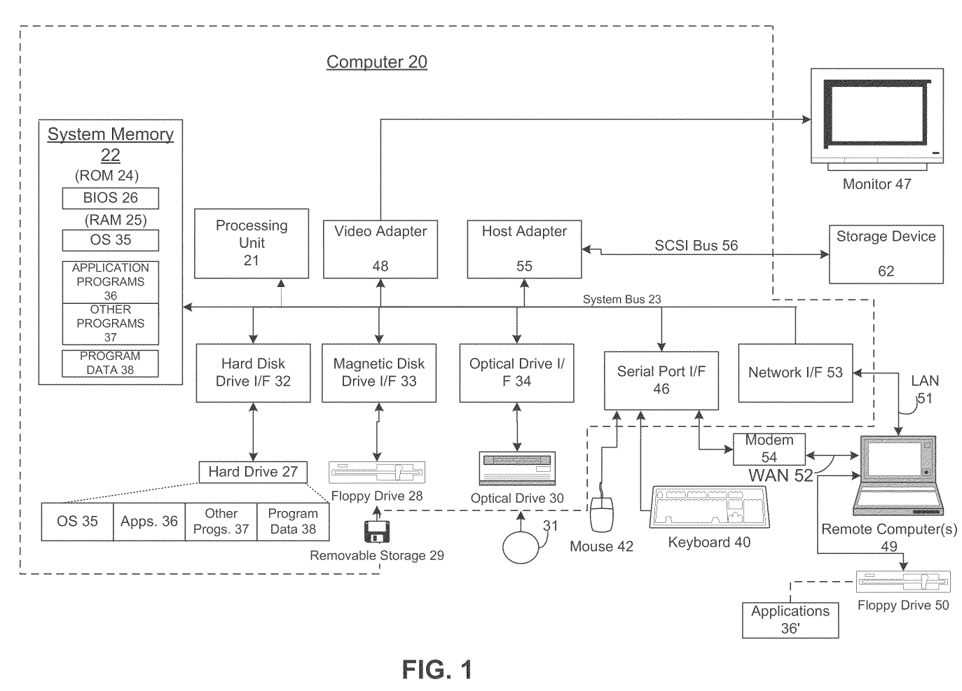

A virtual machine monitor, such as a hypervisor, is a program that creates virtual machines, each with virtualized hardware resources which may be backed by underlying physical hardware resources. FIG. 1 a illustrates a virtual machine environment 100, with a plurality of virtual machines 120, 121, comprising a plurality of virtual processors 110, 112, 114, 116, and corresponding guest operating systems 130, 132. The virtual machines 120, 121 are maintained by a virtualizing layer 140 which may comprise of a scheduler 142 and other components (not shown), where the virtualizing layer 140 virtualizes hardware 150 for the plurality of virtual machines 120, 121. The plurality of virtual processors 110, 112, 114, 116 can be the virtual counterparts of underlying hardware physical processors 160, 162.

All of these variations for implementing the above mentioned partitions are just exemplary implementations, and nothing herein should be interpreted as limiting the disclosure to any particular virtualization aspect.

### Encoding/Decoding of Tiled Data

Described herein is a system and method for encoding and decoding electronic information, and may include an encoding system with a tiling module that initially divides source image data into data tiles. A frame differencing module may then output only altered data tiles to various processing modules that convert the altered data tiles into corresponding tile components.

In an embodiment, a quantizer may perform a compression procedure upon the tile components to generate compressed data according to an adjustable quantization parameter. An adaptive entropy selector may then select one of a plurality of available entropy encoders to perform an entropy encoding procedure to thereby produce encoded data. The entropy encoder may also utilize a feedback loop to adjust the quantization parameter in light of current transmission bandwidth characteristics.

The process of encoding and decoding may generally use one or more methods and systems described in commonly assigned U.S. Pat. No. 7,460,725 entitled “System And Method For Effectively Encoding And Decoding Electronic Information,” hereby incorporated by reference in its entirety.

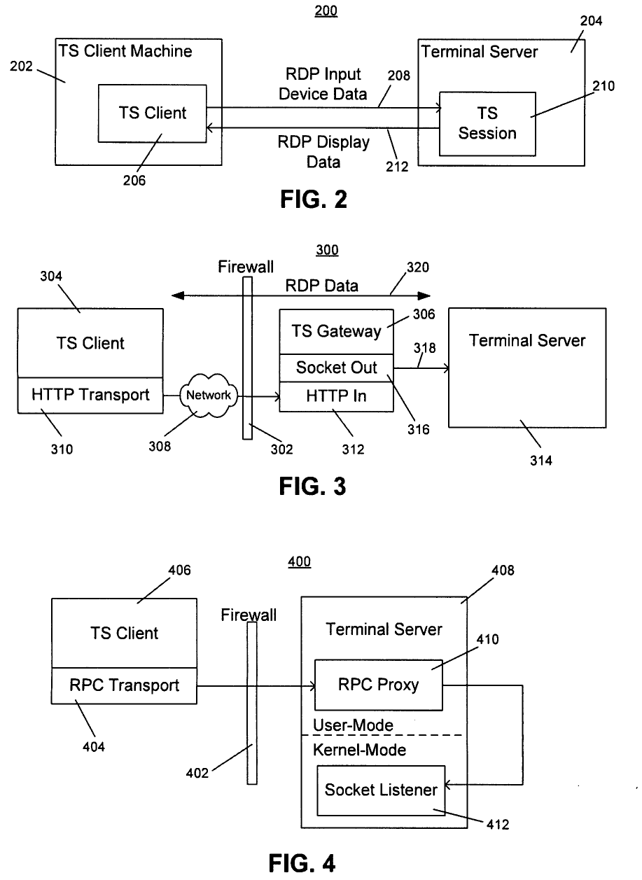

Referring to FIG. 5, a block diagram of an encoding system 500 is shown, in accordance with one embodiment of the present disclosure. In alternate embodiments, encoding system 500 may be implemented using components and configurations in addition to, or instead of, certain of those components and configurations discussed below in conjunction with the FIG. 5 embodiment. For example, encoding system 500 is discussed in the context of processing image data. However, in alternate embodiments, certain concepts and techniques from the present disclosure may be similarly utilized for processing other types of electronic information.

In the FIG. 5 embodiment, encoding system 500 may initially receive source image 501 as a frame of image data from any appropriate data source. A tiling module 502 then divides source image 501 into individual tiles that are implemented as contiguous sections of image data from source image 501. The individual tiles may be configured in any desired manner. For example, in certain embodiments, an individual tile may be implemented as a pixel array that is 128 pixels wide by 128 pixels high.

A frame differencing module 504 may compare the current source image 501, on a tile-by-tile basis, with similarly-located comparison tiles from a previous frame 505 of input image data. To reduce the total number of tiles that require encoding, frame differencing module 504 then outputs via path 506 only those altered tiles from the current source image 501 that are different from corresponding comparison tiles in previous frame 505.

DC shift module 507 may next add a constant DC voltage value to each pixel from the tiles that are output from frame differencing module 504. A color converter 508 also converts each of the tiles from a first color format to a second color format that is appropriate for further processing by encoding system 500. For example, in certain embodiments, source image 501 may initially be received in an RGB format that color converter 508 then responsively converts into a corresponding YUV format.

A discrete wavelet transform module (DWT) 510 may perform a known discrete wavelet transform procedure to transform the individual YUV components of the tiles into corresponding YUV tile subbands. Additional details of discrete wavelet transforms are further discussed in “The JPEG 2000 Still Image Compression Standard,” by Athanassios Skodras et al., published in IEEE Signal Processing Magazine, September 2001.

A quantizer module 511 may next perform a quantization procedure by utilizing appropriate quantization techniques to compress the tile subbands. In the FIG. 5 embodiment, quantizer 511 may produce compressed image data 512 by reducing the bit rate of the tiles according to a particular compression ratio that may be specified by an adaptive quantization parameter 515 received via a feedback loop from entropy encoder 513.

Entropy encoder 513 may perform an entropy encoding procedure to generate encoded data 514. In certain embodiments, the entropy encoding procedure further reduces the bit rate of the compressed image data by substituting appropriate codes for corresponding bit patterns in the compressed image data received from quantizer 511.

In certain alternate embodiments, a System-On-Chip (SOC) device may include encoding system 500 in conjunction with a Central Processing Unit (CPU) and/or a Graphics Processing Unit (GPU). The Graphics Processing Unit may programmatically perform a Discrete Wavelet Transform analysis function to feed subbands to a quantizer. The Graphics Processing Unit may also include Context-Adaptive Binary Arithmetic Coding (CABAC) encoders for generating encoded data from the compressed data received from the quantizer.

This form of integration is efficient because the data for encoding is available to the Graphics Processing Unit, and does not have to be provided by Direct Memory Access techniques into memory of the encoding systems for processing. A corresponding decoding system or System-On-Chip may include other processing elements including a Graphics Processing Unit for performing traditional graphics processing operations such as Bit Block Transfers (BitBlit), up and down scaling, line drawing, as well as supporting a robust windowing system.

In the FIG. 5 embodiment, encoding system 500 is disclosed and discussed as being implemented primarily as hardware circuitry. In certain embodiments, encoding system 500 may be implemented as a single integrated-circuit device. However, in alternate embodiments, some or all of the functions of the present disclosure may be performed by appropriate software instructions that are executed to effectively perform various functions discussed herein.

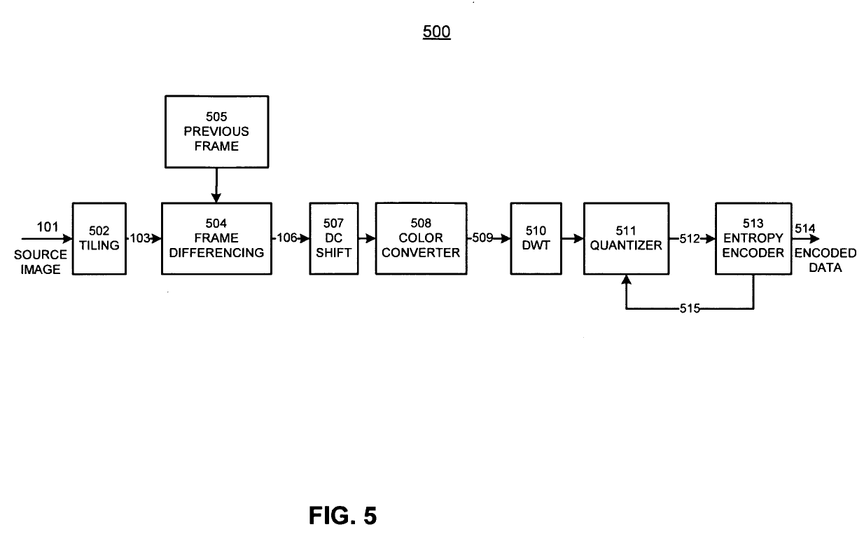

Referring now to FIG. 6, a block diagram of a decoding system 600 is shown, in accordance with one embodiment of the present disclosure. In alternate embodiments, decoding system 600 may be implemented using components and configurations in addition to, or instead of, certain of those components and configurations discussed in conjunction with the FIG. 6 embodiment. For example, in the FIG. 6 embodiment, decoding system 600 is discussed in the context of processing image data. However, in alternate embodiments, certain concepts and techniques from the present disclosure may be similarly utilized for processing other types of electronic information.

In the FIG. 6 embodiment, decoding system 600 may initially receive encoded data 514 that is provided from one or more data sources in any appropriate encoding format. An entropy decoder 602 may perform an entropy decoding procedure to convert encoded data 514 into compressed image data 603. In certain embodiments, the entropy decoding procedure increases the bit rate of encoded data 514 by substituting appropriate bit patterns for corresponding codes in the encoded data 514 to produce compressed image data 603 in a YUV format.

A dequantizer module 604 next performs a dequantization procedure by utilizing appropriate dequantization techniques for decompressing the compressed image data 603 to produce various corresponding tile subbands. For example, in certain embodiments, dequantizer 604 produces the tile subbands by performing dequantization based upon the quantization setting of quantizer 511 during encoding. In the FIG. 6 embodiment, an inverse discrete wavelet transform module (inverse DWT) 605 may perform a known inverse discrete wavelet transform procedure to reverse a corresponding discrete wavelet transform procedure by converting individual tile subbands into corresponding individual tiles that are output on path 606.

A color converter 607 may then convert each of the individual tiles from a first color format to a second color format for further processing by decoding system 600. For example, in certain embodiments, the individual tiles received by color converter 607 may be converted from a YUV format into a corresponding RGB format. A DC shift circuit 608 may next subtract a predetermined constant DC voltage value from each pixel of the tiles that are output from color converter 607.

A frame reconstructor 610 may then compare the current frame of image data, on a tile-by-tile basis, with similarly-located comparison tiles from a previous frame 611 of image data to reconstruct the current frame with the total number of tiles that were previously subject to a frame differencing procedure by frame differencing module 104 of FIG. 5. Frame reconstructor 610 may then output the reconstructed image 612 for utilization by any appropriate entity.

Furthermore, in certain alternate embodiments, decoding system 600 may be implemented as part of a System-On-Chip (SOC) device in which a CABAC decoder of decoding system 600 is shared by inverse DWT 605 and an H.264 Integer Transform decoding system. The CABAC decoder may process data in an H.264 mode and in an enhanced Discrete Wavelet Transform mode under program control. The CABAC encoder may operate on a wavelet-based tile in Discrete Wavelet Transform mode, and may process a separate video bitstream for the H.264 mode.

In the FIG. 6 embodiment, decoding system 600 is disclosed and discussed as being implemented primarily as hardware circuitry. In certain embodiments, decoding system 600 may be implemented as a single integrated-circuit device. However, in alternate embodiments, some or all of the functions of the present disclosure may be performed by appropriate software instructions that are executed to effectively perform various functions discussed herein.

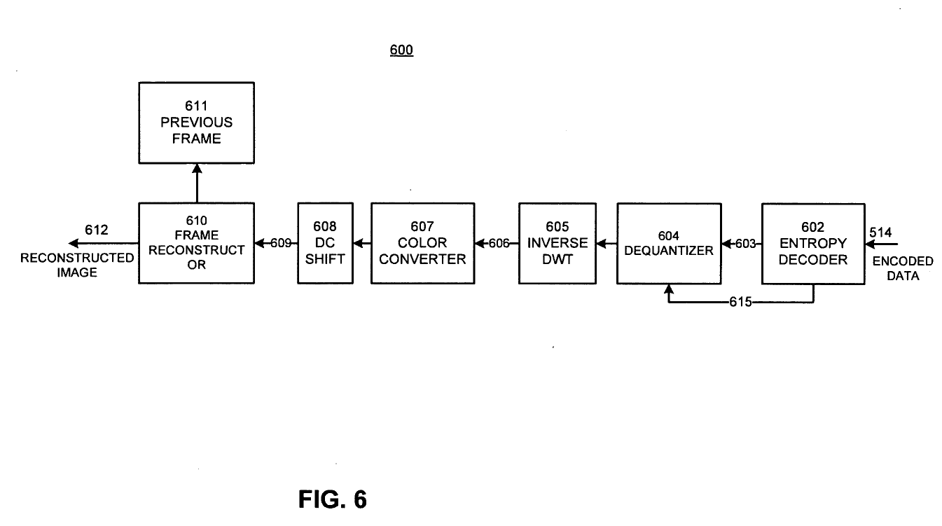

Referring now to FIG. 7, a diagram illustrating a frame differencing procedure is shown, in accordance with one embodiment of the present disclosure. The embodiments depicted in FIG. 7 and following are presented for purposes of illustration, and in alternate embodiments, the present disclosure may readily perform frame differencing procedures using techniques and configurations in addition to, or instead of, certain of those techniques and configurations discussed in conjunction with the depicted embodiments.

In the FIG. 7 embodiment, frame differencing module 504 may store a previous frame 505 of image data that has been segmented into a series of discrete tiles 1-20 by tiling module 502 (FIG. 5). In the FIG. 7 embodiment, frame differencing module 504 performs the frame differencing procedure using any appropriate techniques for comparing corresponding tiles of previous frame 505 and current frame 705 to determine whether the pixels in any of the compared tiles have been altered.

In the FIG. 7 drawing, for purposes of illustration, altered tiles in current frame 705 are indicated with the letter “n” following the tile number. For example, current frame 705 includes altered tiles 3n, 7n, 8n, 9n, and 13n. Instead of processing all current frames 705, frame differencing module 504 efficiently outputs via path 506 only those altered tiles that are different from corresponding tiles from previous frame 505. In the FIG. 7 embodiment, frame differencing module 504 outputs an altered frame 707 that is populated only with altered tiles 3n, 7n, 8n, 9n, and 13n. If a current frame 705 exhibits no changed tiles with respect to previous frame 505, then the unaltered current frame 705 is not output by frame differencing module 504. The foregoing frame differencing procedure may significantly reduce the processing requirements for encoding system 500 (FIG. 5) and decoding system 600 (FIG. 6).

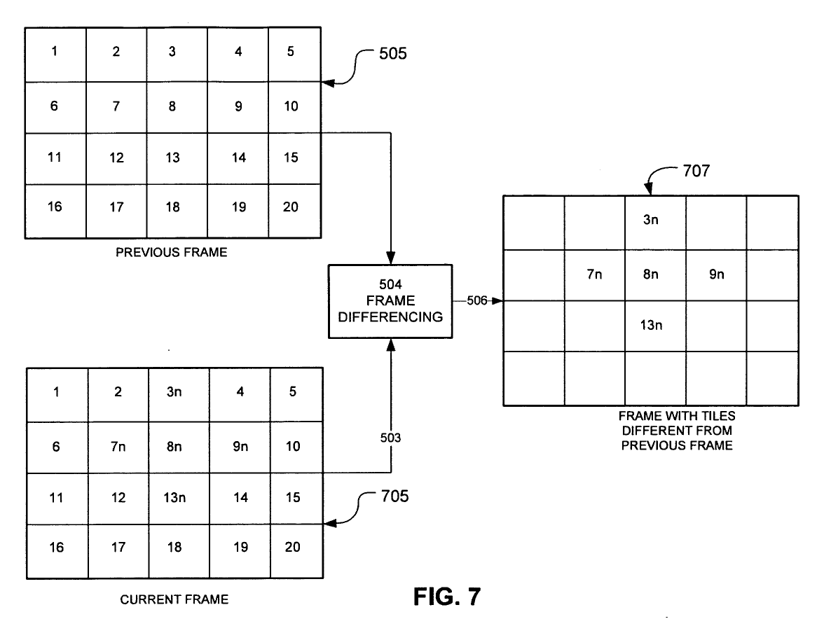

Referring now to FIG. 8, a diagram illustrating a frame reconstruction procedure is shown, in accordance with one embodiment of the present disclosure. In the FIG. 8 embodiment, frame reconstructor 610 may store a previous frame 611 of image data that is segmented into a series of discrete tiles 1-20. Frame reconstructor module 610 may perform the frame reconstruction procedure using appropriate techniques for comparing corresponding tiles of previous frame 611 and a received frame 707 to determine whether the pixels in any of the compared tiles have been altered. Received frame 707 preferably is the same or similar to the “frame with tiles different from previous frame” that is shown as the output of frame differencing module 504 in FIG. 6.

In the FIG. 8 drawing, for purposes of illustration, altered tiles in frame 707 are indicated with the letter “n” following the tile number. For example, frame 707 includes altered tiles 3n, 7n, 8n, 9n, and 13n. To reverse the frame differencing procedure described in FIG. 7, frame reconstructor 610 may utilizes any number of appropriate techniques to reconstruct the original current frame 705 that was initially processed by frame differencing module 504 in FIG. 7. For example, frame reconstructor 610 may output a current frame 705 that is populated with the altered tiles 3n, 7n, 8n, 9n, and 13n from frame 707, and the remaining unaltered tiles 1-2, 4-6, 10-12, and 14-20 from previous frame 611. The foregoing frame reconstruction procedure thus supports the prior frame differencing procedure of FIG. 7 to provide significantly reduced processing requirements for encoding system 500 (FIG. 5) and decoding system 600 (FIG. 6).

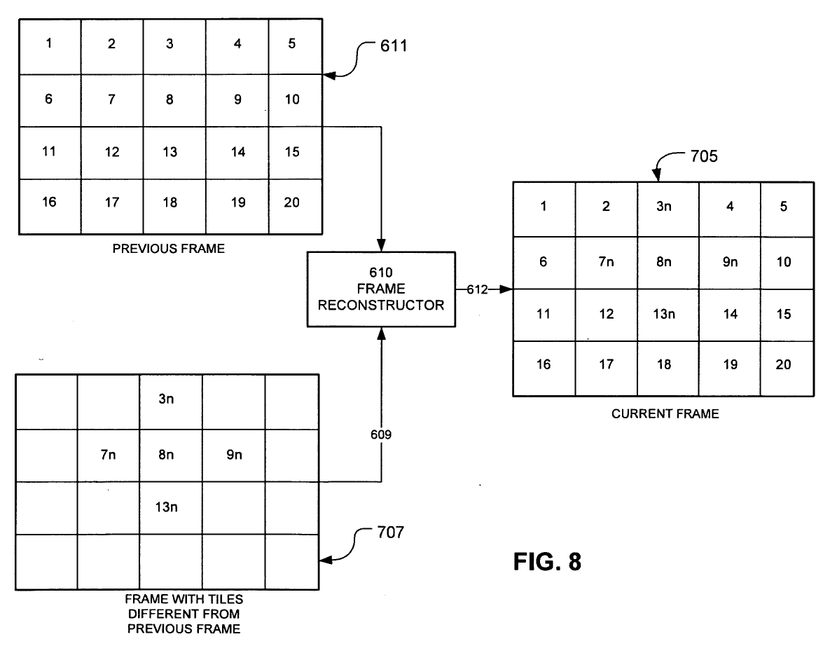

Referring now to FIG. 9, a block diagram for the FIG. 5 entropy encoder 513 is shown, in accordance with one embodiment of the present disclosure. In alternate embodiments, entropy encoder 513 may be implemented using components and configurations in addition to, or instead of, certain of those components and configurations discussed in conjunction with the FIG. 9 embodiment.

In the FIG. 9 embodiment, entropy encoder 513 may include an adaptive entropy selector 912 (including a rate controller), a Context-Based Adaptive Binary Arithmetic Coding (CABAC) Encoder 916, and a Run-Length Encoding encoder (RLE) 920. CABAC encoder 916 may be selected to perform an entropy encoding procedure in accordance with a known H.264 CABAC standard. Further details about the H.264 CABAC encoding process are discussed in “Context-Based Adaptive Binary Arithmetic Coding,” by Marpe, Detlev, et al., in the H.264/AVC Video Compression Standard, IEEE Transactions On Circuits And Systems For Video Technology, Vol. 13, No. 7, July 2003.

Entropy encoder 513 may alternately select and activate RLE encoder 920 to perform entropy encoding procedures in accordance with certain known run-length encoding techniques. Further details about various types of run-length encoding techniques may be found and reviewed on-line at the following Internet web page address: http://en.wikipedia.org/wiki/Run-length_encoding.

The CABAC encoder 916 is typically implemented as one or more hardware circuits, while RLE encoder 920 is typically implemented to perform entropy encoding procedures in response to the execution of entropy encoding software instructions.

Adaptive entropy selector 912 may initially receive compressed data 512 from quantizer 511 of FIG. 5. Adaptive entropy selector 912 may sense currently available transmission bandwidth and memory resources for entropy encoder 513. Because certain versions of encoding system 500 and/or decoding system 200 may not support CABAC encoding and/or decoding, adaptive entropy selector 912 may also determine whether CABAC encoders/decoders are available for performing corresponding entropy encoding and/or decoding processes.

Based upon the foregoing encoding selection criteria, adaptive entropy selector 912 may be configured to select either CABAC encoder 916 or RLE encoder 920 to perform the current entropy encoding procedure. For example, if available transmission bandwidth and memory resources are relatively low, adaptive entropy selector 912 may select CABAC encoder 916. Similarly, if a higher degree of compression is required, adaptive entropy selector 912 may select CABAC encoder 916. Alternately, if CABAC encoding is not currently supported, adaptive entropy selector 912 may select RLE encoder 920. Similarly, if transmission bandwidth and memory resources are sufficiently available, then adaptive entropy selector 912 may consider selecting RLE encoder 920 for performing the entropy encoding process.

Adaptive entropy selector 912 may include a rate controller that adjusts and provides an adaptive quantization parameter 515 via a feedback loop to quantizer 511 (FIG. 5) to produce compressed image data 512 by altering the bit rate of compressed image data 512 according to a particular compression ratio that is specified by the adaptive quantization parameter 515. The rate controller of adaptive entropy selector 912 may determine picture quality characteristics of encoded data 514 by utilizing various appropriate criteria or techniques.

The rate controller of adaptive entropy selector 912 may then adjust adaptive quantization parameter 515 to decrease the amount of compression if encoded data 514 exhibits unacceptable picture quality, or if bandwidth characteristics of the downstream channel are insufficient. Conversely, the rate controller may adjust adaptive quantization parameter 515 to increase the amount of compression if the picture quality of encoded data 514 is not particularly critical. In addition, the rate controller may adjust adaptive quantization parameter 515 to decrease the amount of compression in compressed image data 512 when available memory and/or transmission bandwidth becomes relatively scarce. Conversely, the rate controller may adjust adaptive quantization parameter 515 to increase compression levels of compressed image data 512 when available memory and/or transmission bandwidth is sufficiently available and improved picture quality is desired.

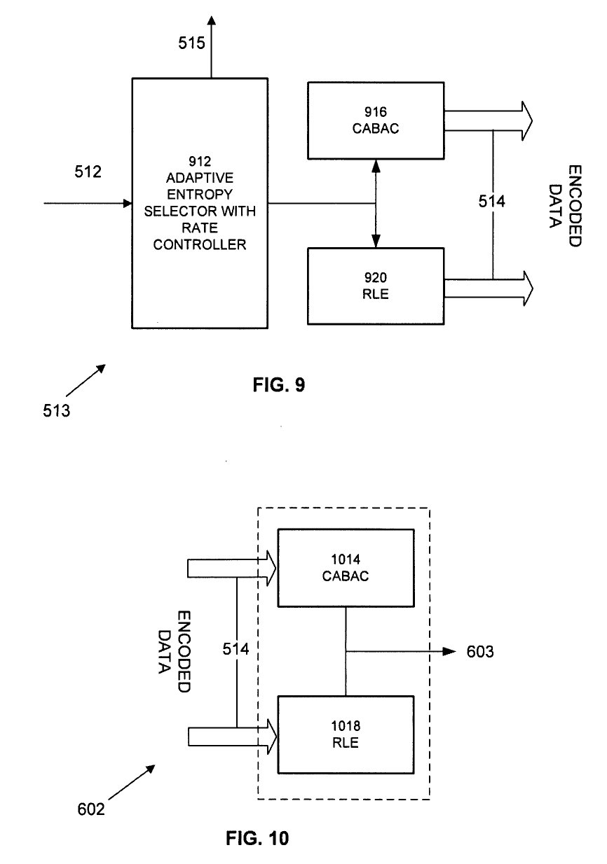

Referring now to FIG. 10, a block diagram for the FIG. 6 entropy decoder 602 is shown, in accordance with one embodiment of the present disclosure. In the FIG. 10 embodiment, entropy decoder 602 may include a CABAC decoder 1014 and an RLE decoder 1018. CABAC decoder 1014 may be selected to perform known entropy decoding procedures to effectively reverse the entropy encoding procedure performed by CABAC encoder 516 of FIG. 9. In certain embodiments, CABAC decoder 1014 may be selected to perform an entropy decoding procedure in accordance with a known H.264 CABAC standard that is discussed above in conjunction with FIG. 9.

Alternately, RLE decoder 920 may be selected to perform known entropy decoding procedures to effectively reverse the entropy encoding procedure performed by RLE encoder 920 of FIG. 9. In certain embodiments, entropy decoder 602 may select RLE decoder 1018 to perform appropriate entropy decoding procedures in accordance with various known run-length decoding standards that are discussed above in conjunction with RLE encoder 920 of FIG. 9.

Entropy encoder 602 may initially receive encoded data 514 from any appropriate data source. In response, entropy encoder 602 may analyze encoded data 514 to determine whether encoded data 514 is configured in a CABAC-encoded format or in an RLE-encoded format. Entropy encoder 602 may then activate either CABAC decoder 1014 or RLE decoder 1018 to perform an entropy decoder procedure, depending upon the type of encoding format of the encoded data 514.

For example, if encoded data 514 is received in a CABAC-encoded format, then entropy decoder may 602 utilize CABAC decoder 1014 to decode encoded data 514 to provide corresponding compressed image data 603 to dequantizer 204 (FIG. 6). Alternately, if encoded data 514 is received in an RLE-encoded format, then entropy decoder 602 may utilize RLE decoder 920 to decode encoded data 514 to provide corresponding compressed image data 603 to dequantizer 204.

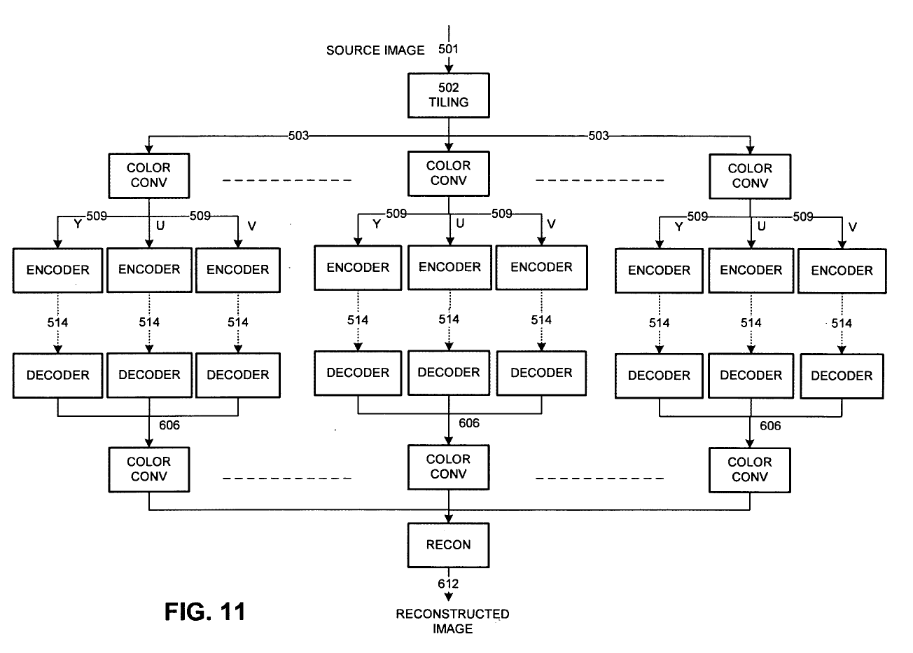

Referring now to FIG. 11, a block diagram for a multiple encoder-decoder architecture is shown, in accordance with one embodiment of the present disclosure. In the FIG. 11 embodiment, a tiling module 502 initially receives a source image 501 as a frame of image data from any appropriate data source. Tiling module 502 then divides source image 501 into individual tiles that are preferably implemented as contiguous sections of image data from source image 501. The individual tiles 503 are each sent to one of a series of different color converters that each convert respective received tiles from a first color format to a second color format. For example, in certain embodiments, source image 501 may initially be received in an RGB format which the color converters responsively convert into corresponding YUV components 509 on a tile-by-tile basis.

A series of encoders are shown configured in parallel to concurrently encode the YUV components 509. These encoders may be implemented in any appropriate manner. For example, in certain embodiments, each of the encoders may be implemented to include DWT 510, quantizer 511, and entropy encoder 513 from the FIG. 1 embodiment of encoding system 500. Each of the YUV components 509 are separately provided to a different one of the parallel encoders for concurrent encoding to significantly improve throughput characteristics of the encoding process. Each of the YUV components 509 may then be concurrently output from a respective one of the parallel encoders as encoded data 514.

In the FIG. 11 embodiment, a series of decoders are shown configured in parallel to concurrently decode respective components of encoded data 514. These decoders may be implemented in any appropriate manner. For example, in certain embodiments, each of the parallel decoders may be implemented to include entropy decoder 602, dequantizer 504, and inverse DWT 605 from the FIG. 2 embodiment of decoding system 600. Each of the components of encoded data 514 are separately provided to a different one of the parallel decoders for concurrent decoding to significantly improve throughput characteristics of the decoding process.

Each of decoders may then concurrently output a respective one of the decoded YUV components 606 to a corresponding color converter which converts and combines the YUV components 606 into a composite image (such as a composite RGB image). A frame reconstructor (RECON) may then provide a reconstructed image 612 to any appropriate image destination.

The multiple encoder/decoder architecture is shown with a matching number of encoders and decoders. However, in alternate embodiments, encoder/decoder architectures are also contemplated with non-matching numbers of encoders and decoders. For example, a server computer may require a larger number to encoders to efficiently process a large amount of data for use by separate client computers that each require a relatively reduced numbers of decoders.

In addition, multiple encoder/decoder architectures may similarly be utilized to separately encode and/or decode individual images in a parallel manner for utilization by different data destinations. Furthermore, in certain embodiments, an individual encoder or decoder may be implemented with a plurality of entropy encoders that are configured in parallel to support a single encoding system. For example, the encoding system 500 of FIG. 5 and/or the decoding system 600 of FIG. 6 may be implemented with a plurality of appropriate CABAC encoders 516 or CABAC decoders 614 configured in parallel so that other system components need not wait in an idle state for completion of lengthy entropy encoding or decoding procedures.

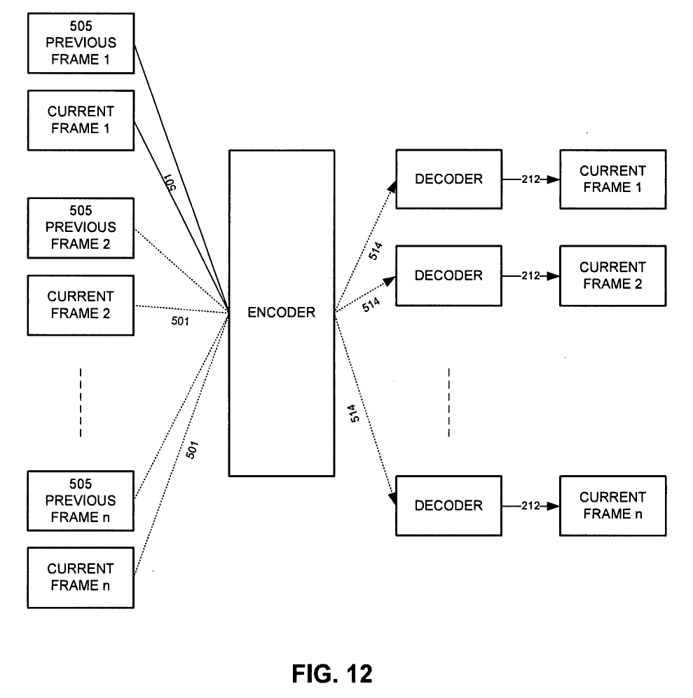

Referring now to FIG. 12, a block diagram illustrating a multiple image encoding/decoding procedure is shown, in accordance with one embodiment of the present disclosure. In the FIG. 12 embodiment, a single encoder is shown concurrently encoding an image 1 through an image n, and providing the respective encoded images to appropriate decoders. The encoder may be implemented in any effective manner. For example, in certain embodiments, the FIG. 12 encoder may include, but is not limited to, any of the components shown in the encoding system 500 of FIG. 1.

The encoder stores previous frames 1 through n (505) from respective corresponding images. The FIG. 12 encoder also receives current frames 1 through n of source images 501 from any appropriate destination(s). The FIG. 12 encoder then concurrently processes the current frames 501 using any appropriate techniques to generate corresponding encoded data 514. For example, in certain embodiments, the FIG. 12 encoder utilizes encoding techniques that are the same as, or similar to, those encoding techniques discussed above in conjunction with FIGS. 5, 7, and 9.

In the FIG. 12 embodiment, the encoder may then provide the individual frames of encoded data 514 to respective decoders that are configured in parallel to concurrently decode corresponding frames of encoded data 514. These decoders may be implemented in any appropriate manner. For example, in certain embodiments, the FIG. 12 decoders may each include, but are not limited to, any of the components shown in decoding system 600 of FIG. 2.

The FIG. 12 decoders may then concurrently process the encoded data 514 using an appropriate technique to generate corresponding current frames 1 through n of reconstructed images 612. For example, in certain embodiments, the FIG. 12 decoders utilize decoding techniques that are the same as, or similar to, those decoding techniques discussed above in conjunction with FIGS. 6, 8, and 10. In the FIG. 12 embodiment, the reconstructed images 612 may then be provided to any appropriate image destination.

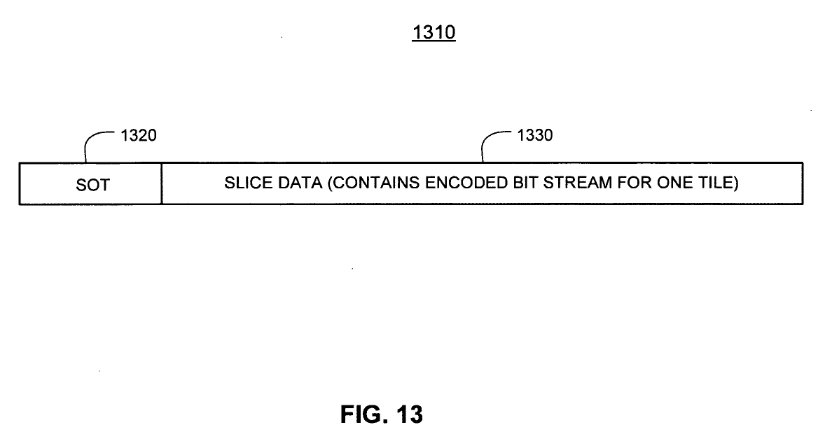

Referring now to FIG. 13, a diagram for tile data 1310 is shown, in accordance with one embodiment of the present disclosure. In the FIG. 13 embodiment, tile data 1310 includes a Start Of Tile (SOT) header 1320 and slice data 1330. The FIG. 13 embodiment is presented for purposes of illustration, and in alternate embodiments, tile data 1310 may be implemented using components and configurations in addition to, or instead of, certain of those components and configurations discussed in conjunction with the FIG. 13 embodiment.

The FIG. 13 embodiment illustrates the data format for storing or transmitting encoded data 514 for each tile. The start of tile header (SOT) 1320 consists of various different selectable parameters that are used to reconstruct the tile and embed the tile into to a current frame of image data. For example the SOT 1320 may include quantization parameters for various subbands, a length of an associated encoded information, and offset values to facilitate decoding procedures. The SOT 1320 may be followed by the slice data 1330 that may include an encoded bit stream corresponding to one associated tile. In the FIG. 13 embodiment, the slice data may be encoded in any appropriate format. For example, in certain embodiments, slice data may be encoded either by the CABAC encoder 916 or by the RLE encoder 920 discussed above in conjunction with FIG. 9.

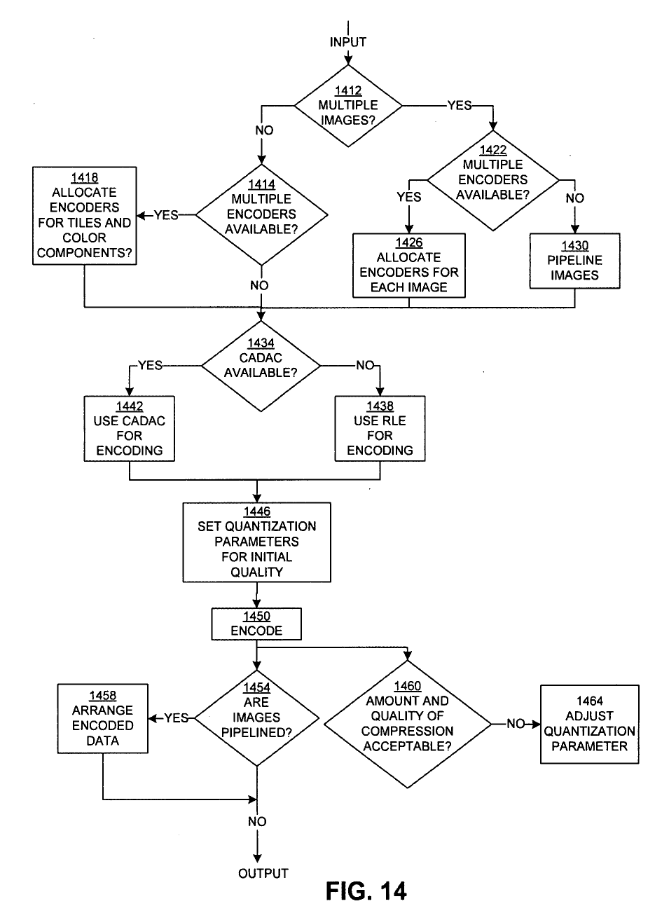

Referring now to FIG. 14, an exemplary operational procedure for performing an encoding procedure is shown, in accordance with one embodiment of the present disclosure. In the FIG. 14 embodiment, in operation 1412, an encoding system 500 receives input data, and responsively determines whether the input data includes multiple images. If only a single image source is being received, then in operation 1414, encoding system 500 determines whether multiple encoders are available for processing the image. If multiple encoders are available, then in operation 1418, encoding system 500 allocates the encoders to separately and concurrently process the individual tiles of the different color components in a parallel manner.

Alternately, if multiple images are received, then in operation 1422, encoding system 500 determines whether multiple encoders are available for processing the images. If multiple encoders are available, then in operation 1426, encoding system 500 allocates the encoders to separately and concurrently process the multiple images in a parallel manner. If multiple encoders are not available, then in operation 1430, encoding system 500 performs a pipelining procedure for passing the multiple images through the encoding process.

In operation 1434, encoding system 500 determines whether CABAC encoding/decoding is supported. If a CABAC encoding/decoding is available, then in operation 1442, encoding system 500 utilizes the CABAC encoder 916 to perform the entropy encoding procedure. However, if a CABAC encoding/decoding is not available, then in operation 1438, encoding system 500 utilizes a RLE encoder 920 to perform the entropy encoding procedure.

In operation 1446, encoding system 500 sets a quantization parameter at an initial image quality level that corresponds to a particular compression ratio 515 of a quantizer 511 (FIG. 5). Then, in operation 1450, encoding system 500 encodes the image(s) in a pre-determined encoding format. In operation 1454, encoding system 500 determines whether the images are pipelined. If the images are not pipelined, then encoding system 500 outputs the encoded data 514 to an appropriate data destination. Alternately, if the images are pipelined, in operation 1458, encoding system 500 arranges the encoded data 1458 before outputting the encoded data 514 to an appropriate data destination.

In operation 1460, encoding system 500 determines whether the compression amount and quality of the output images are acceptable. If the amount and quality of compression are not acceptable according to pre-defined criteria, then in operation 1464, encoding system 500 dynamically utilizes a feedback loop to adjust the quantization parameter 515 for altering the compression ratio of quantizer 511 to thereby change the amount and quality of the encoding compression.

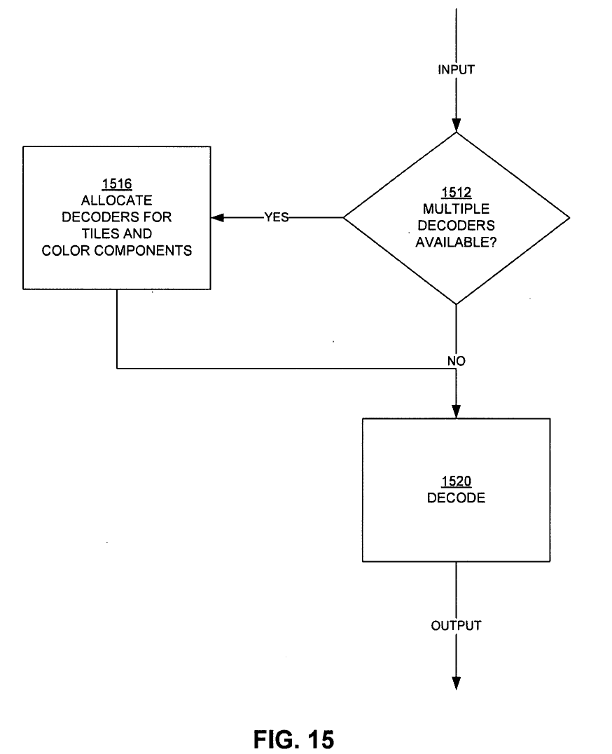

Referring now to FIG. 15, an exemplary operational procedure for performing a decoding procedure is shown, in accordance with one embodiment of the present disclosure. In the FIG. 15 embodiment, a decoding system 600 initially receives input data in the form of encoded data 914. Then in operation 1512, decoding system 600 determines whether multiple decoders are available for processing the encoded data 514. If multiple encoders are available, then in operation 1516, decoding system 600 allocates the decoders to separately and concurrently process the individual tiles of the different color components in a parallel manner. In operation 1520, decoding system 600 next decodes the image data in a predetermined manner to produce a reconstructed image 612. Decoding system 600 then outputs the reconstructed image 612 to any appropriate data destination(s).

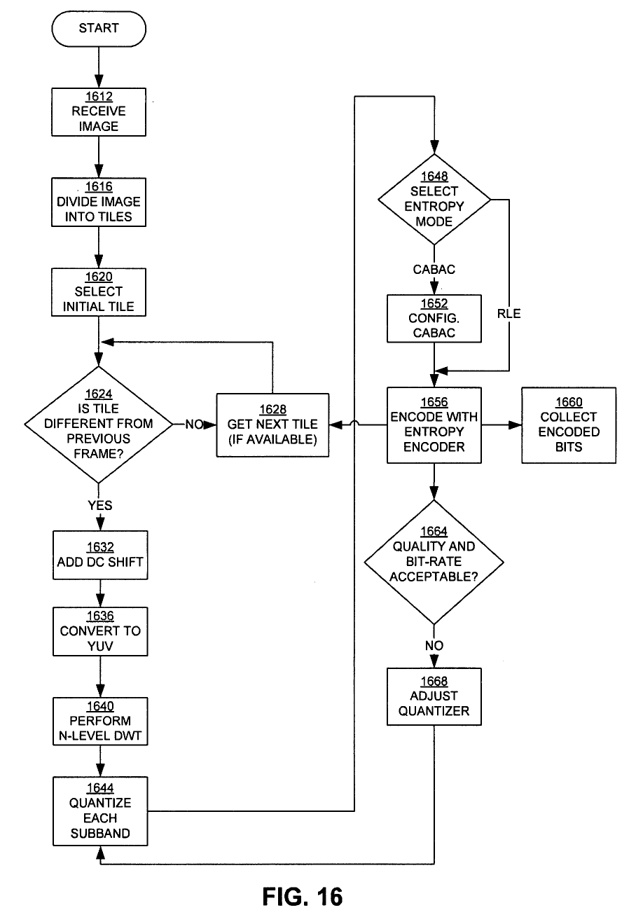

Referring now to FIG. 16, an exemplary operational procedure for performing an encoding procedure is shown, in accordance with one embodiment of the present disclosure. In the FIG. 16 embodiment, in operation 1612, an encoding system 500 initially receives a source image 501 from any appropriate data source. The source image 501 may be configured according to any desired data format. For example, in certain embodiments, the source image 501 may be implemented as an array of digital picture elements (pixels) in a known RGB format. In operation 1616, encoding system 500 utilizes a tiling module 502 to divide the source image 501 into individual tiles that are implemented as contiguous sections of image data from the source image 501.

In operation 1620, encoding system 500 selects a current tile from the source image 501. Then in operation 1624, a frame differencing module 504 compares the current tile to a corresponding comparison tile from a previous frame 505 to determine whether the current tile has been altered with respect to the comparison tile from the immediately preceding frame 505. If the pixels in the current tile have not been altered, then frame differencing module 504 does not output the current tile. Instead, in operation 1628, frame differencing module 504 accesses the next tile (if available) from source image 501, and the FIG. 16 process returns to repeat foregoing operation 1624.

However, in operation 1624, if one or more pixels in the current tile have been altered, then frame differencing module 504 outputs the corresponding tile to a DC shift module 507 that adds a constant DC voltage value to each pixel from the tiles that are output from frame differencing module 504. In operation 1636, a color converter 508 converts each of the altered tiles from a first color format to a second color format that is appropriate for further processing by encoding system 500. For example, in certain embodiments, source image 501 may initially be received in an RGB format which color converter 508 responsively converts into a corresponding YUV format.

In the FIG. 16 embodiment, a discrete wavelet transform module (DWT) 510 performs a known discrete wavelet transform procedure (DWT) to transform the individual color components of the tiles into corresponding color subbands. A quantizer module 511 next performs a quantization procedure by utilizing appropriate quantization techniques to compress the color subbands. Quantizer 511 produces compressed image data 512 by reducing the bit rate of the color subbands according to a particular compression ratio that is specified by an adaptive quantization parameter 515.

In operation 1648, an adaptive entropy selector 512 next selects an appropriate entropy mode (either CABAC mode or RLE mode) for performing an entropy encoding procedure based upon certain pre-determined encoding mode selection criteria. If CABAC mode is selected, then in operation 1652, encoding system 500 advantageously performs a CABAC configuration procedure that defines certain specific configuration parameters for operating a CABAC encoder 516 to optimally process the compressing image data 512 received from quantizer 511.

In operation 1656, an entropy encoder 513 performs an entropy encoding procedure upon the compressed data 512 by utilizing the entropy mode (either CABAC mode or RLE mode) that was selected in foregoing operation 1648. In operation 1660, encoding system 500 may then collect the encoded data 514 for providing to any appropriate data destination(s). At this point, the FIG. 16 process may be repeated for additional tiles by returning to operation 1628, where frame differencing module 504 accesses the next tile from source image 501 (if any unprocessed tiles remain).

In operation 1364, encoding system 500 may further perform a bit-rate control procedure by initially determining whether the quality and bit-rate of encoded data 514 are acceptable in light of one or more pre-defined image assessment criteria. In operation 1664, if encoding system 500 determines that the quality and bit-rate of encoded data 514 are not acceptable, then in operation 1668, a bit rate controller of entropy encoder 513 provides an adaptive quantization parameter 515 via a feedback loop to quantizer 511 to alter the bit rate of compressed image data 514 according to a particular compression ratio that is specified by the adaptive quantization parameter 515.

As described above, a graphics bitmap may be divided into tiles. Furthermore, when a tile is sent from the server to the client, the tile data may be encoded to reduce the amount of data sent over the network. It can be seen that the encoding/decoding process involves a series of operations that are preferably performed at a rate that supports the continuous reception and generation of graphics on the client side such that the user can be provided a high quality and timely display experience. Some of the described encoding/decoding operations may be performed on the entire tile, e.g. discrete wavelet transformation and quantization. The discrete wavelet transformation process involves repeated operations and feeding the results of one stage into the next stage.

For example, a 128×128 tile may be transformed into four 64×64 subtiles that may represent combinations of high and/or low frequency components or subbands. Each of these four subtiles may then be transformed into four 32×32 subtiles, each of which may then be transformed into four 16×16 subtiles. At each intermediate level, it is preferable that the output of one stage be immediately fed into the next stage without the need to store the result. Each of the resulting subtiles may then be directly quantized and entropy encoded. In a hardware implementation, such operations may be performed efficiently and quickly. In general, however, entropy encoding, which is typically at the last stage of the encoding process described above, is slower in throughput and may be more processor intensive. Furthermore, processing requirements tend to increase as a function of the magnitude of the data coefficients produced during the encoding phase. It is desirable to preserve the coefficient values without any loss of fidelity. However, the storing of intermediate values is not desired because of the time required to perform I/O operations and the amount of memory required. The entire intermediate result would need to be stored before proceeding to the succeeding processing stage, which may result in performance penalties due to the movement into and out of memory as well as the number of processing cycles needed.

Accordingly, the above algorithms may be adapted such that the tiles or subtiles are divided into two or more segments that may be independently processed. In various embodiments, the segments may comprise “slices” of the tile or subtile. In one embodiment, a tile or subtile may be logically divided into four slices of equal size. Each slice of the tile data may then be independently and/or concurrently processed. Depending on the specific format used, the slicing process may be performed for each image component. For example, if a YUV format is used, then the slicing process may be performed for each of the three YUV components or their transformed subtiles.

The processing may further be implemented in software, custom hardware, or both. When the slice processing is implemented in software, the programming may utilize the multi-core CPUs that are typically used in many computing systems. The program may be thus be written such that each core processes a slice of the tile data. If a tile is divided into four slices and the slices are processed on four CPU cores, the total processing time can be reduced to about a quarter of the time it would take to process the entire tile without slicing.

When the slice processing is implemented in hardware, the hardware may be designed to instantiate 1, 2 or 4 or more instances of a slice processing engine. In an embodiment, the slice processing engine may implement an encoder slice engine that performs entropy encoding on a slice of tile data. An arbiter function may also be provided that collects the data from a prior stage, logically divide the data into slices, and distribute the data slices to the slice engines.

On the client side, one or more decoder slice engines may perform the reverse of entropy encoding on a receive slice of encoded tile data. The output of each decoder slice engine may then be combined and then passed to the next processing stage which may process the combined data tile. For example, four entropy decoder slice engines may receive four slices for concurrent processing. The output of each concurrent process may then be logically combined and passed to the de-quantization phase.

As mentioned, the data slices are independent and may be processed independently. In an embodiment, each slice may be associated with different areas of memory. Because the output of a compression stage requires variable storage space, it may not be possible to plan in advance the amount of memory that should be reserved for a process. The data may thus be placed into different areas of memory during processing. Upon completion of processing, the processed slices may be concatenated to produce the complete result.

The preferred number of slices may be determined according to the specific needs of the system and the processing techniques used. A trade off can be determined between the number of processors and the size of the data. For example, if the tile size is 128×128 and a discrete wavelet transformation is used, 16×16 subtiles will be produced after three intermediate stages. The 16×16 subtile may then be divided into four 16×4 slices that may be processed by four slice engines. Using two slice engines with 16×8 slices will not likely provide the improvement in throughput that is desired, and eight slices with 16×2 slices will not likely provide an efficient balance between the increased number of processes and a notable improvement in throughput.

While the tile slicing procedure has been described in terms of a process that utilizes discrete wavelet transformation, quantization, and entropy encoding, the concept can be readily applied to various compression/encoding processes that may involve one ore more types of data transformation, quantization and encoding processes.

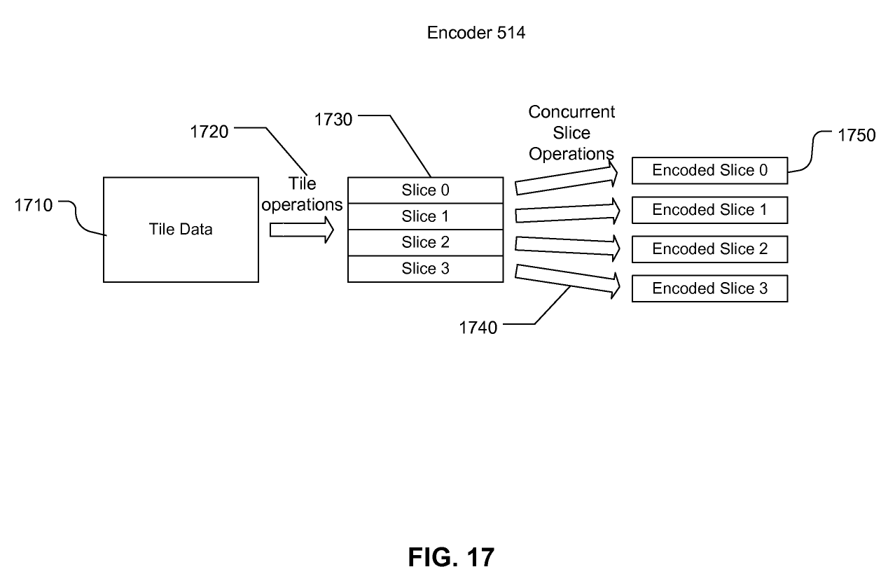

Referring to FIG. 17, illustrated is an example embodiment of a sliced tile encoding mechanism. Tile data 1710 may comprise a tile comprising bitmap data representing a portion of a virtual machine user display to be transmitted to a client device. Tile operations 1720 may represent various operations described above for processing the received data tiles. The operations may further include processes for dividing the tile into two or more slices. In the example shown, the tile data 1710 is divided into four slices 1730 for concurrent processing 1740. In an embodiment the four slices may be logical slices that divide the tile data 1710 into four equal size slices. For example, a 16×16 tile may be divided into four 4×16 slices.

The slices 1730 may be further processed to generate processed slices 1750. As discussed above, the process may include encoding techniques such as entropy encoding. The processed slices 1750 may then be transmitted to a client computer for decoding. The slices may be transmitted over any type of network protocol and over wired or wireless networks.

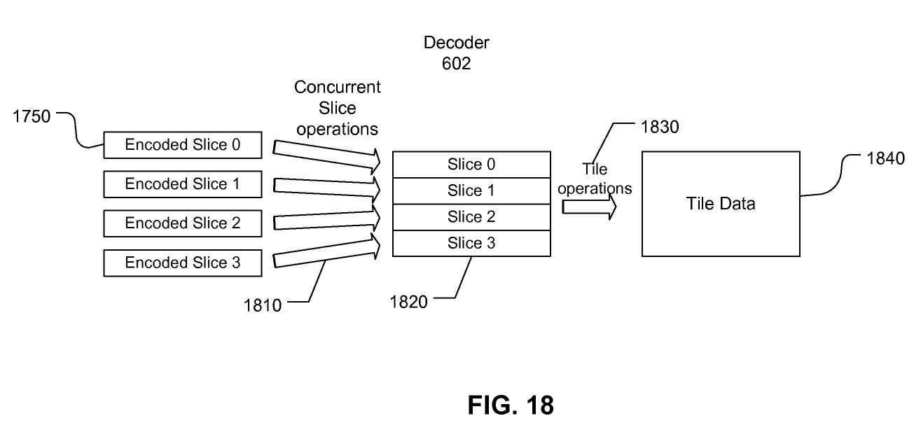

Referring to FIG. 18, the processed slices 1750 may be received by a decoder 602 on the client computer. The slices 1750 may then be processed concurrently 1810. For example, the slices may be decoded using a reverse entropy decoding technique to recover the original data slices 1820. The decoded slices may further be concatenated and further processed 1830 using, for example, dequantization and inverse transform operations. The original data tile 1840 may thus be re-generated.

### Frame Capture and Processing

In various methods and systems disclosed herein, improvements to the processing and handling of the various processes described above may be used to provide more efficient processing and thus a more timely and rich user experience. The methods and systems also provide for improvements in providing such graphics support when the network and/or system resources become congested or otherwise less available. The embodiments disclosed herein for rendering, encoding and transmitting graphics data may be implemented using various combinations of hardware and software processes. In some embodiments, functions may be executed entirely in hardware. In other embodiments, functions may be performed entirely in software. In yet further embodiments, functions may be implemented using a combination of hardware and software processes. Such processes may further be implemented using one or more CPUs and/or one or more specialized processors such as a graphics processing unit (GPU) or other dedicated graphics rendering devices.

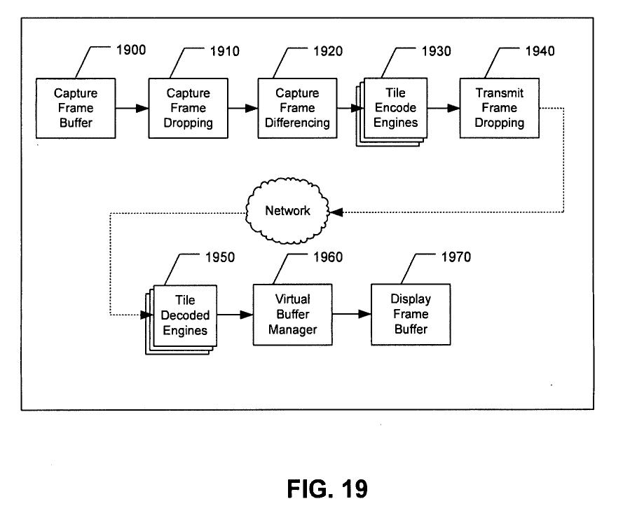

Referring to FIG. 19, illustrated is an overview of various functions associated with the rendering and encoding processes discussed herein. Various aspects of the illustrated process may be modified to improve the throughput and efficiency of the processes. Process 1900 illustrates the capturing and buffering of a client frame. Process 1910 illustrates that under certain circumstances it may be advantageous to drop a captured frame. The term dropping may include ignoring the captured data in favor of the next captured frame data, clearing the buffers of the captured data, and the like. Process 1920 illustrates that the captured frame may be analyzed to determine if differences exist compared to the previously captured frame. Process 1930 illustrates the process of encoding the changed tiles of a frame. Process 1940 illustrates that under certain circumstances it may be advantageous to drop a frame that has been encoded and is ready to transmit. The term dropping may include ignoring the encoded data in favor of the next encoded frame, clearing the transmit buffers of the encoded data, and the like. Once transmitted, process 1950 illustrates that the received tiles may be decoded. Process 1960 illustrates that the receive buffers may be managed to track changed tiles. Process 1970 illustrates that the display frame buffers may be used to drive the display controller in an efficient manner. Various aspects of the above processes are further detailed below.

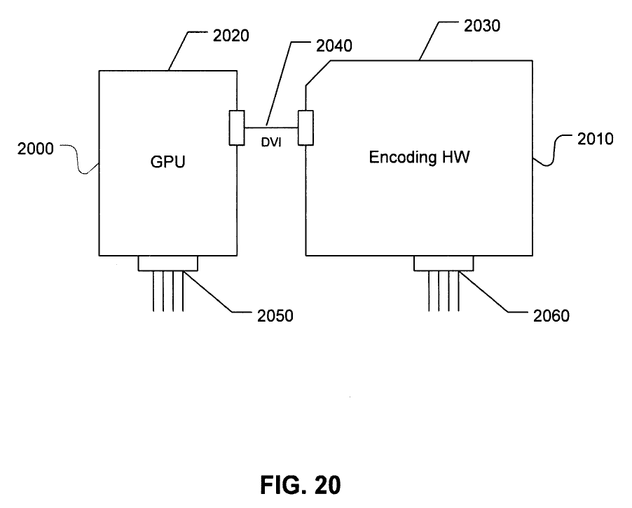

Rendering of client frame graphics data may be performed on the system's central processing unit (CPU), a specialized graphics processing unit (GPU), or custom hardware. If the rendering is performed on a CPU, the rendered graphics may be transferred to the encoding system through a PCI-Express interface. If the rendering is performed on the GPU, the graphics data may be transferred through a video link such as a DVI interface if provided. In this manner memory access may be avoided, thus providing improved speed of operation. Alternatively, if rendering is done in the custom hardware, for example using an on-chip 2D engine, transferring of the data may be unnecessary. For example, referring to FIG. 20, a GPU 2000 may communicate with encoding hardware 2010 to transmit rendered graphics data for encoding. Rather than transferring data through connector 2050 to transmit over a system bus to connector 2060 of encoding hardware 2010, the GPU 2000 may directly communicate with the encoding hardware 2010 via a DVI connection 2040.

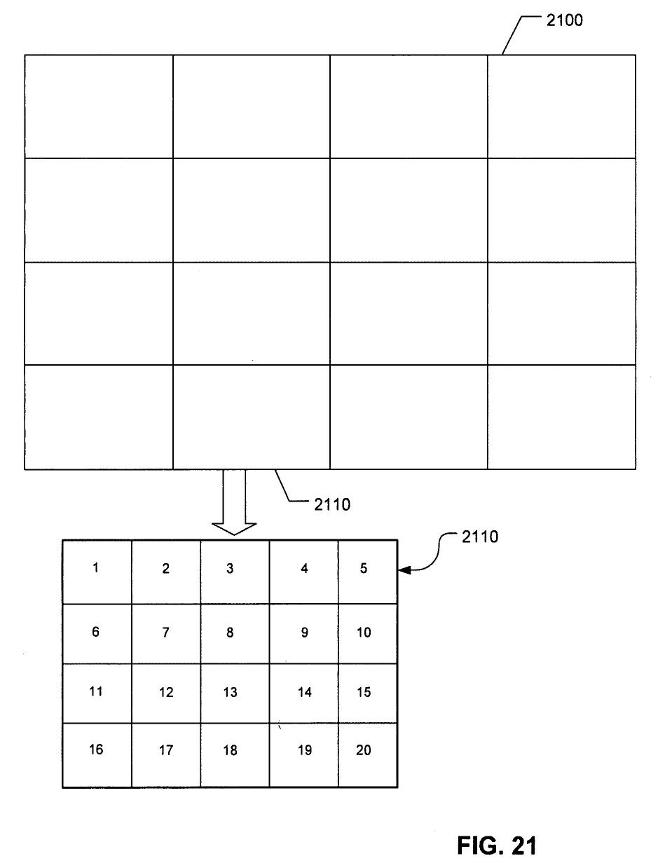

As discussed above, a video frame may be logically partitioned into a plurality of smaller tiles. If rendering is performed on a GPU, the client screen data may be arranged using a variety of schemes. In one embodiment, a virtual frame mode may be used wherein multiple client screens are spatially composed within a single virtual screen. This embodiment can be conceptualized as one large screen comprised of multiple client sessions. In this embodiment all clients may have the same update/refresh rate. Each frame may be captured, however only the changed tiles may be processed according to the processes disclosed above. For example, referring to FIG. 21, a virtual frame 2100 to be transmitted to the encoding system may comprise sixteen client frames. An exemplary client screen 2110 may further be divided into twenty tiles and encoded using the techniques described herein.

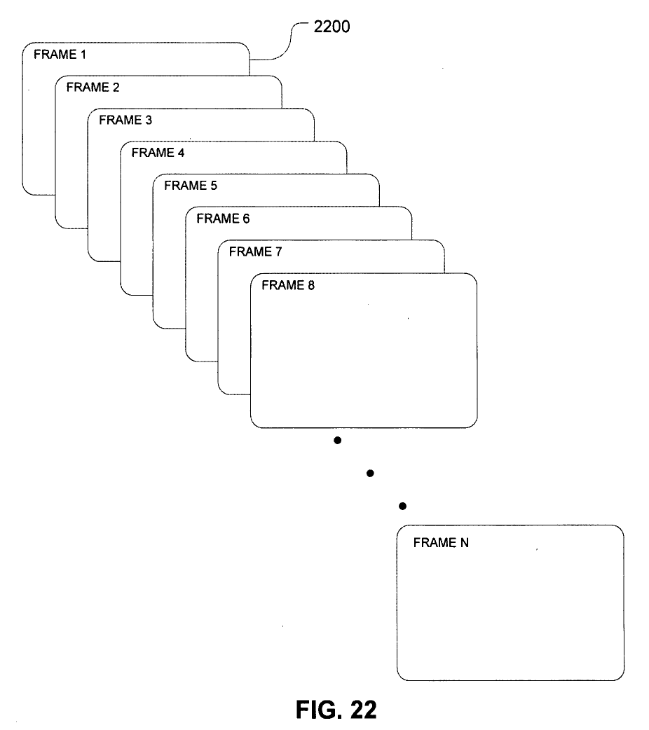

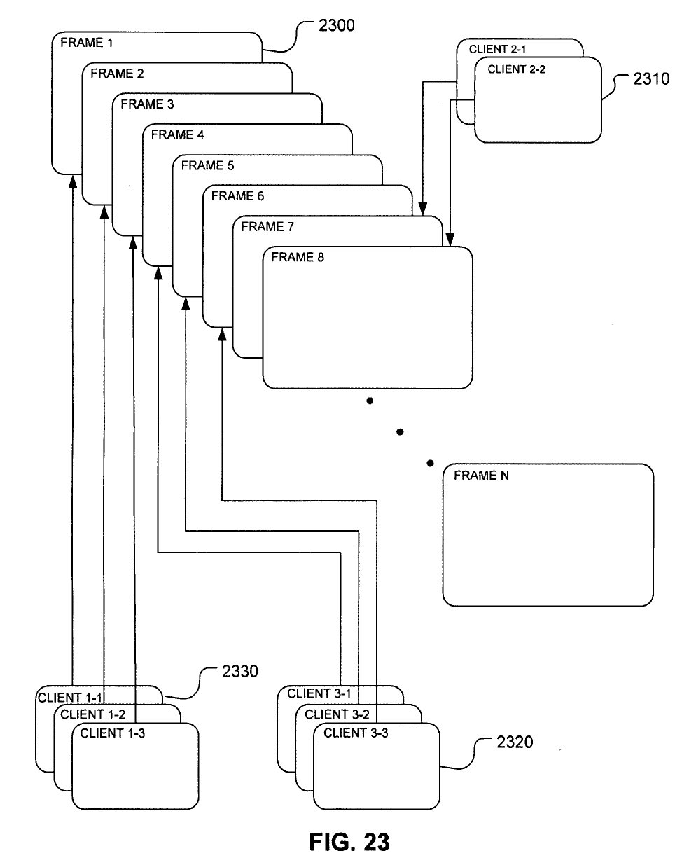

In another embodiment, a temporal frame mode may be provided in which each client frame may occupy one time slot of the server frame sequence and one frame may be provided to the encoding engine at one time. In this embodiment, each client may have its own update/refresh rate. Each screen may further be embedded with information describing which client the frame is destined for. For example, a client with minimal updates may be relatively idle and may only need a low refresh rate. Clients with high update rates, for example a client playing a video, may be captured by being provided more time slots. For example, referring to FIG. 22, each of frames 2200 may represent a single capture frame of a plurality of capture frames. The individual frames may be apportioned to various clients in order to support refresh rates supporting the type and nature of the client activity. Referring to FIG. 23, the individual frames of frame sequence 2300 may be apportioned between frames for client 1 2330, client 2 2310, and client 3 2320. For example, frames 1-1, 1-2, and 1-3 of client 1 2330 maybe assigned to frames 1, 2, and 3 of frame sequence 2300. Frames 2-1 and 2-2 of client 2 2310 may be assigned to frames 7 and 8 of frame sequence 2300. Finally, frames 3-1, 3-2, and 3-3 of client 3 2320 may be assigned to frames 4, 5, and 6 of frame sequence 2300.

Various methods may be used to identify the correct client destination for each transmitted frame. For example, additional lines may be added to the top of a frame as information for client identification.

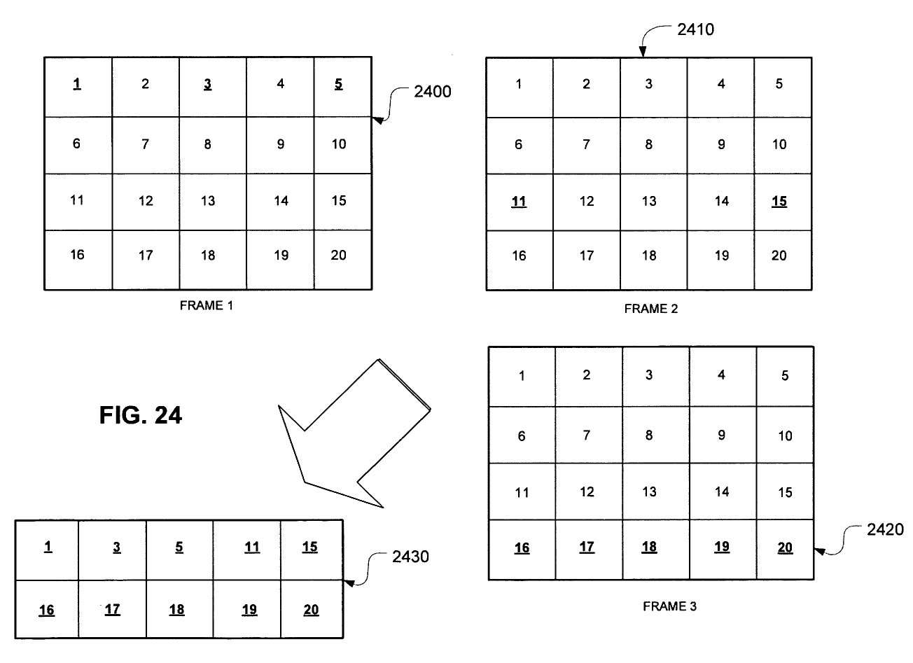

In another embodiment, a changed-tile mode may be provided that tracks which tiles have changed and providing only the changed tiles to the encoding engine for processing. For example, the CPU may keep track of which tiles are changed, and only the changed tiles may be provided for further processing. For example, 4×5 tiles may be implemented for a screen. In this embodiment, only tiles that changed may be transferred for that screen. Referring to FIG. 24, frame 1 2400 may include three changed tiles 1, 3 and 5 (emphasized by bolded and underlined tile numbers). Frame 2 2410 may include two changed tiles 11 and 15. Frame 3 2420 may include five changed tiles 16, 17, 18, 19 and 20. The resulting sequence of tiles 2430 sent to the encoding system may include the set of changed tiles from the three frames, including tiles 1, 3, 5, 11, 15, 16, 17, 18, 19, and 20.

Various methods may be used to transfer the changed tiles. For example, the changed tiles may be bit block transferred to the display frame and sent across the link to the encoding engine. In this fashion, changed tiles from multiple clients can be included within a server display frame. The tiles may further be embedded with information on which client the tile belongs. In an embodiment, the first tile row may be used to provide information about the rest of the tiles such as client association, frame number, tile offset, and the like.

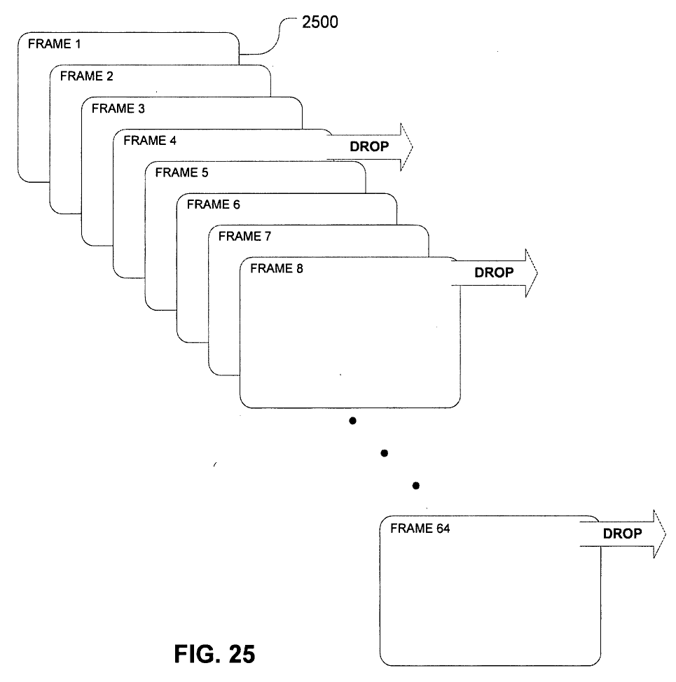

In some embodiments, the capture rate of the graphics source data may be adjusted in response to current system and network limitations. For example, during the course of a remote desktop application, encoded data queued for transmission may be delayed due to network congestion. The continued queuing and delay of the transmissions may result in data being lost when the transmit buffers become full and new data is not stored. Likewise, if the new data is not merged with existing data, the new data may be lost and the queued data, once transmitted, may be stale due to the transmit delay. When a new frame is transmitted after one or more frames have been lost due to the network congestion, the result may be a jerky or otherwise poor quality video on the client side. In one embodiment, a virtual frame mode may be provided, wherein the video capture logic can be programmed to capture a fraction of the incoming frames. In an embodiment, the capture frame can be divided into 1/64 increments. For example, if the system determines that the network is congested and data may be lost, the capture rate can be programmed to capture 3 out of every 4 frames. Accordingly, every fourth frame may be dropped or skipped (i.e., frame 4, 8, 16, and so on). Since the current network and system resources are such that it is not possible to capture every frame, the system may more efficiently utilize resources by adjusting the capture rate as a function of the current system and network conditions. Referring to FIG. 25, illustrated is an exemplary sequence of capture frames 2500. If the system determines that network congestion is preventing the transmission of every frame, the system may adjust the capture rate such that 3 out of every 4 frames should be captured. Accordingly, as shown, frames 4, 8 and so on through frame 64 may be dropped.

When the encoding processing cannot keep up with the capture rate, the incoming frame may be written over the current captured data. When such overwriting is repeated, indicating a network or processing issue, the process may be configured to re-program the capture rate to a slower rate.

In some embodiments, improvements in frame processing and encoding can be provided by more efficiently performing captured frame differencing to determine if a frame has changed since the previous frame. While hardware logic may be used to determine whether tiles between the current frame and previous frame have changed, the disclosed methods may be implemented in software. In an embodiment, a CRC value of a tile may be stored as a reference for comparison, in lieu of directly comparing the actual tile data. By calculating the CRC, the result can be quickly compared to the stored CRC to determine if there any differences in the data. The changed tiles may then be compressed and encoded. In embodiments where only changed tiles are compressed/encoded, all changed tiles may be received for compressed/encoded. However, while encoding, the CRC may be calculated to see if the tile has changed. If the tile has not changed, then the tile may not be transmitted.

As noted above, a heavily loaded network or slow processing client may result in loss of data because queued data may not be timely transmitted. In such cases, the process may allow the capture and encoding process to continue such that currently queued data is overwritten or otherwise “dropped.” In an embodiment, newly encoded tiles may replace stale unsent tiles in system memory. This process may be repeated for additional tiles while the network backlog situation continues. Since the system resources are such that it may not be possible to transmit every frame, the system may more efficiently utilize resources by adjusting the capture rate as a function of the current system and network conditions while at the same time accumulating the changes indicated by the video data. Once the network is available and the data can be transmitted, the latest encoded set of tiles may be transmitted across the network to the client. The net effect on the client side is that some frames may be skipped. However, the resulting display will typically provide a better response compared to current approaches where the most recent changes are dropped because the earlier frames have not yet been transmitted and remain in the queue.

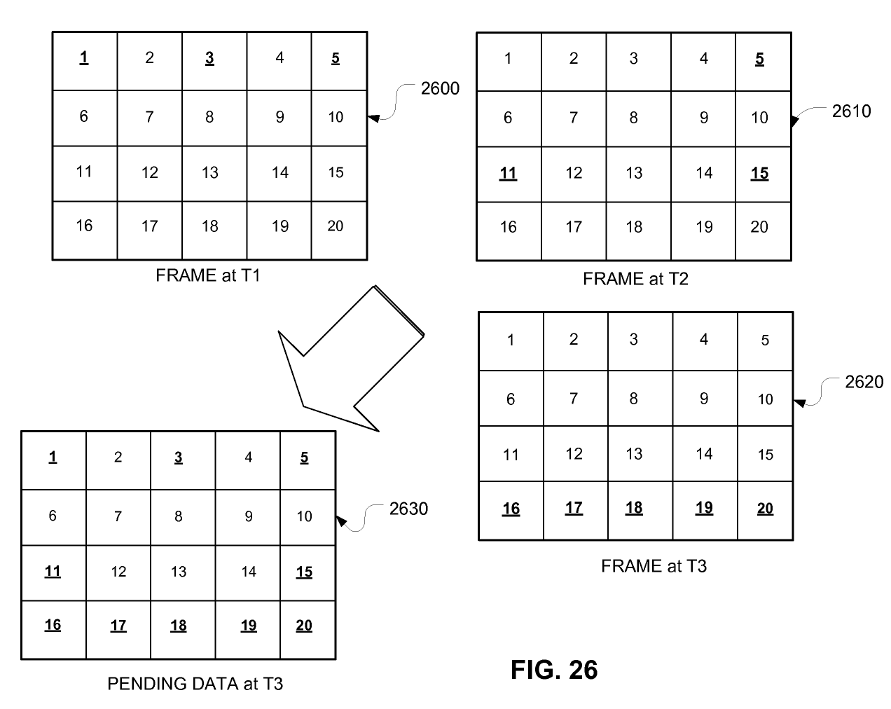

For example, referring to FIG. 26, a frame 2600 comprising twenty tiles may include three changed tiles 1, 3, and 5 during time T1 that are encoded and queued for transmission. Because of network congestion, the currently pending frame is not transmitted, thus being overwritten by frame 2610 at time T2. At T2 only frames 5, 11, and 15 have changed. The current tile 5 from time T2 will overwrite the currently queued tile 5 from T1. Tiles 11 and 15 have not previously changed, and the tiles from T2 are now queued for transmission, along with tiles 1 and 3 from time T1. If network congestion continues, then at time T3 a newly captured frame 2620 results in tiles 16, 17, 18, 19, and 20 being encoded as changed tiles. The resulting data awaiting transmission at time T3 is depicted by frame 2630 which indicates the accumulated changed tiles 1, 3, 5, 11, 15, 16, 17, 18, 19, and 20.

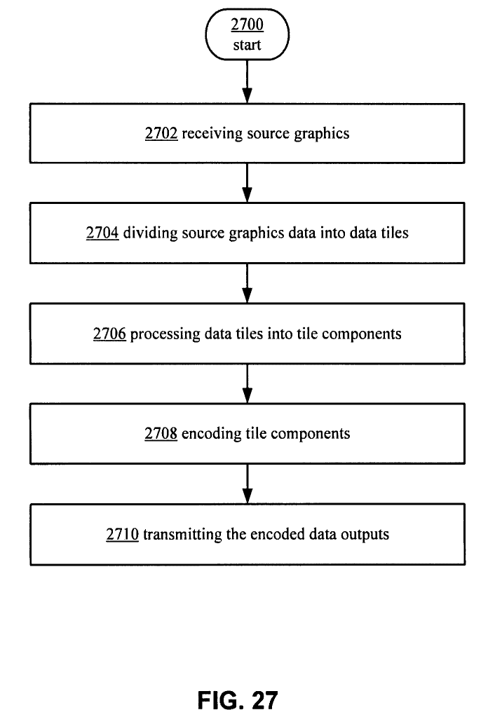

FIG. 27 depicts an exemplary operational procedure for compressing graphics data for transmission to a client computer including operations 2700, 2702, 2704, 2706, 2708, and 2710. Referring to FIG. 27, operation 2700 begins the operational procedure and operation 2702 illustrates receiving source graphics data from a data source, the graphics data representing client screens associated with a plurality of virtual machine sessions. Operation 2704 illustrates dividing said source graphics data into data tiles. Operation 2706 illustrates processing said data tiles into tile components. Operation 2708 illustrates encoding the tile components to produce encoded data outputs. Operation 2710 illustrates transmitting the encoded data outputs to said plurality of client computers.

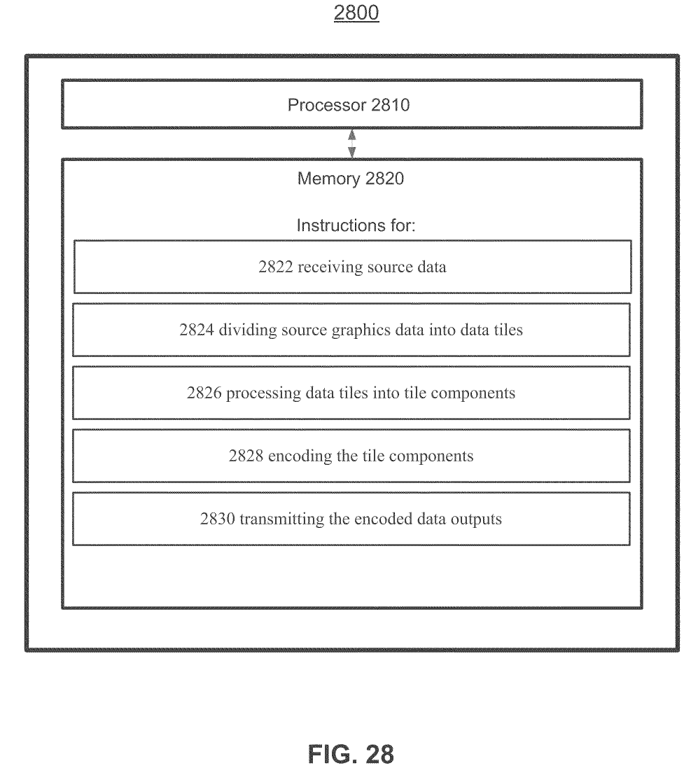

FIG. 28 depicts an exemplary system for compressing data for transmission to a client computer as described above. Referring to FIG. 28, system 2800 comprises a process 2810 and memory 2820. Memory 2820 further comprises computer instructions configured to compress data for transmission to a client computer. Block 2822 illustrates receiving said source graphics data from a data source, the graphics data comprising bitmap data representing client screens representing a plurality of virtual machine sessions. Block 2824 illustrates dividing said source graphics data into data tiles. Block 2826 illustrates processing said data tiles into tile components. Block 2828 illustrates encoding the tile components to produce encoded data outputs, said encoding comprising at least one of transformation, quantization, and entropy encoding. Block 2830 illustrates transmitting the encoded data outputs to said plurality of client computers.

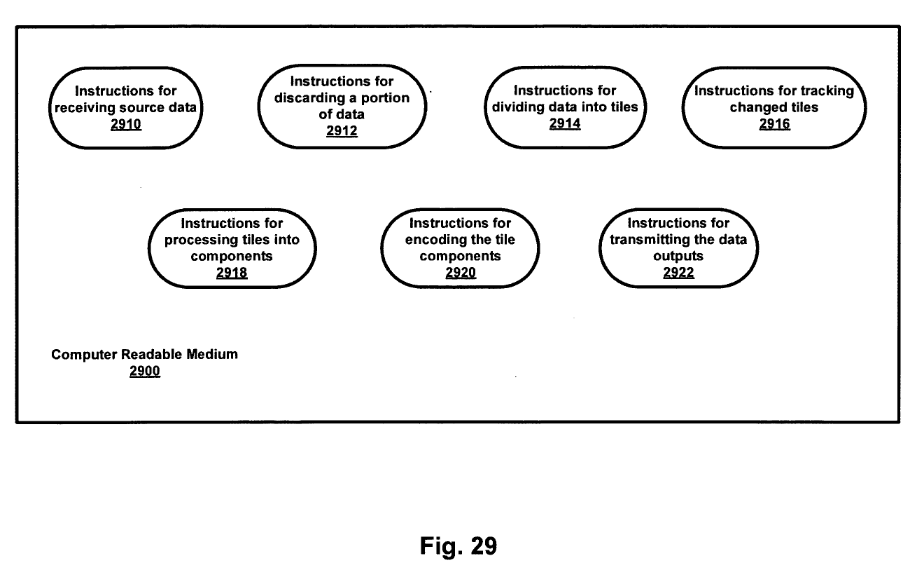

Any of the above mentioned aspects can be implemented in methods, systems, computer readable media, or any type of manufacture. For example, per FIG. 29, a computer readable medium can store thereon computer executable instructions for compressing data for transmission to a client computer. Such media can comprise a first subset of instructions for receiving source graphics data from a data source, the graphics data representing client screens representing a plurality of virtual machine sessions and received at a frame rate determined as a function of a network available bandwidth 2910; a second subset of instructions for discarding at least a portion of said source graphics data as a function of said network available bandwidth 2912; a third subset of instructions for dividing said source graphics data into data tiles 2914; a fourth set of instructions for tracking which of said data tiles are changed by comparing a first checksum of a current data tile to a second checksum of a previous data tile corresponding to the current data tile 2916; a fifth set of instructions, wherein for each of the changed data tiles, processing said data tiles into tile components 2918; a sixth set of instructions, wherein for each of the changed data tiles, for encoding the tile components to produce encoded data outputs 2920; and a seventh set of instructions, wherein for each of the changed data tiles, transmitting the encoded data outputs to said plurality of client computers 2922. It will be appreciated by those skilled in the art that additional sets of instructions can be used to capture the various other aspects disclosed herein, and that the three presently disclosed subsets of instructions can vary in detail per the present disclosure.

As described above, aspects of the disclosure may execute on a programmed computer. FIG. 1 and the following discussion is intended to provide a brief description of a suitable computing environment in which the those aspects may be implemented. One skilled in the art can appreciate that the computer system of FIG. 1 can in some embodiments effectuate the server and the client of FIGS. 2-4. In these example embodiments, the server and client can include some or all of the components described in FIG. 1 and in some embodiments the server and client can each include circuitry configured to instantiate specific aspects of the present disclosure.

The term circuitry used through the disclosure can include specialized hardware components. In the same or other embodiments circuitry can include microprocessors configured to perform function(s) by firmware or switches. In the same or other example embodiments circuitry can include one or more general purpose processing units and/or multi-core processing units, etc., that can be configured when software instructions that embody logic operable to perform function(s) are loaded into memory, e.g., RAM and/or virtual memory. In example embodiments where circuitry includes a combination of hardware and software, an implementer may write source code embodying logic and the source code can be compiled into machine readable code that can be processed by the general purpose processing unit(s).

FIG. 1 depicts an example of a computing system which is configured to with aspects of the disclosure. The computing system can include a computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. In some example embodiments, computer executable instructions embodying aspects of the disclosure may be stored in ROM 24, hard disk (not shown), RAM 25, removable magnetic disk 29, optical disk 31, and/or a cache of processing unit 21. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, a virtual machine, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are examples and other means of establishing a communications link between the computers may be used. Moreover, while it is envisioned that numerous embodiments of the disclosure are particularly well-suited for computer systems, nothing in this document is intended to limit the disclosure to such embodiments.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects and embodiments of the disclosure described herein have been shown and described, it will be apparent to those skilled in the art that, based upon the teachings herein, changes and modifications may be made and, therefore, the appended claims are to encompass within their scope all such changes and modifications as are within the true spirit and scope of the disclosures described herein.

What is claimed:

1. In a system comprising a processor and memory, a method for processing graphics data for transmission to a plurality of client computers, the method comprising:
receiving source graphics data from a data source, the graphics data representing client screens associated with a plurality of virtual machine sessions;
dividing said source graphics data into data tiles and processing said data tiles into tile components;
encoding the tile components to produce encoded data outputs; and
transmitting the encoded data outputs to said plurality of client computers.

2. The method of claim 1, wherein said client screens are spatially concatenated to form a single virtual screen.

3. The method of claim 1, wherein each of said client screens occupy one video frame processing slot.

4. The method of claim 1, further comprising tracking which of said data tiles are changed and performing said dividing, encoding and transmitting steps only for changed data tiles.

5. The method of claim 1, further comprising receiving said source graphics data at a reduced frame rate.

6. The method of claim 5, wherein said reduced frame rate is determined as a function of a network available bandwidth.

7. The method of claim 1, further comprising discarding at least a portion of said source graphics data as a function of a network available bandwidth.

8. The method of claim 4, wherein said tracking which of said data tiles are changed is determined by comparing a first checksum of a current data tile to a second checksum of a previous data tile corresponding to the current data tile.

9. The method of claim 1, further comprising tracking which of said data tiles are changed and transmitting only the changed data tiles.

10. The method of claim 1, further comprising repeating said receiving, dividing and encoding steps for a new set of source graphics data prior to said transmitting when an available network available bandwidth meets a predetermined criterion.

11. The method of claim 10, further comprising tracking which of said data tiles are changed and transmitting said encoded data outputs when a corresponding data tile has changed since a previously transmitted data tile.

12. A system configured to process graphics data for transmission to a plurality of client computers, comprising:
at least one processor; and
at least one memory communicatively coupled to said at least one processor, the memory having stored therein computer-executable instructions for:
receiving said source graphics data from a data source, the graphics data comprising bitmap data representing client screens representing a plurality of virtual machine sessions;
dividing said source graphics data into data tiles and processing said data tiles into tile components;
encoding the tile components to produce encoded data outputs, said encoding comprising at least one of transformation, quantization, and entropy encoding; and
transmitting the encoded data outputs to said plurality of client computers.

13. The system of claim 12, wherein said client screens are spatially concatenated to form a single virtual screen.

14. The system of claim 12, wherein each of said client screens occupy one video frame processing slot.

15. The system of claim 12, further comprising tracking which of said data tiles are changed and performing said dividing, encoding and transmitting steps only for changed data tiles, wherein said changed tiles are determined by comparing a first checksum of a current data tile to a second checksum of a previous data tile corresponding to the current data tile.

16. The system of claim 12, further comprising receiving said source graphics data at a reduced frame rate determined as a function of a network available bandwidth.

17. The system of claim 12, further comprising repeating said receiving, dividing and encoding steps for a new set of source graphics data prior to said transmitting when an available network available bandwidth meets a predetermined criterion.

18. The system of claim 12, further comprising tracking which of said data tiles are changed and transmitting encoded data outputs when a corresponding data tile has changed since a previously transmitted data tile.

19. A computer readable storage medium storing thereon computer executable instructions for processing graphics data for transmission to a plurality of client computers, said instructions for:
receiving source graphics data from a data source, the graphics data representing client screens representing a plurality of virtual machine sessions and received at a frame rate determined as a function of a network available bandwidth;
discarding at least a portion of said source graphics data as a function of said network available bandwidth;
dividing said source graphics data into data tiles; and
tracking which of said data tiles are changed by comparing a first checksum of a current data tile to a second checksum of a previous data tile corresponding to the current data tile, and for each of the changed data tiles:
processing said data tiles into tile components;
encoding the tile components to produce encoded data outputs; and
transmitting the encoded data outputs to said plurality of client computers.

20. The computer readable storage medium of claim 19, further comprising repeating said encoding for a new set of source graphics data prior to said transmitting when an available network available bandwidth meets a predetermined criterion; wherein said transmitting comprises tracking which of said data tiles are changed and transmitting encoded data outputs when a corresponding data tile has changed since a previously transmitted data tile.
